(19) United States
(12) Patent Application Publication
(10) Pub. No.: US 2024/0036836 A1
(43) Pub. Date: Feb. 1, 2024

(54) COMPUTER-READABLE RECORDING MEDIUM STORING INFORMATION PROCESSING PROGRAM, INFORMATION PROCESSING METHOD, AND INFORMATION PROCESSING APPARATUS

(71) Applicant: Fujitsu Limited, Kawasaki-shi (JP)

(72) Inventor: Hayato NISHIMURA, Funabashi (JP)

(73) Assignee: Fujitsu Limited, Kawasaki-shi (JP)

(21) Appl. No.: 18/340,153

(22) Filed: Jun. 23, 2023

(30) Foreign Application Priority Data
Jul. 26, 2022 (JP) 2022-119065

(51) Int. Cl. G06F 8/41

(52) U.S. Cl. CPC G06F 8/41

(57) ABSTRACT

A non-transitory computer-readable recording medium stores an information processing program for causing a computer to execute a process including: acquiring a plurality of pieces of source code; making an expansion of a function corresponding to a module in source code in a case in which a definition of the module is included in the source code and when the module is not included in a predetermined library, for each of the plurality of pieces of source code acquired; and specifying a group including two or more pieces of source code to be subjected to annotation work together among the plurality of pieces of source code, based on a result of comparing each of the plurality of pieces of source code after the expansion.

### CROSS-REFERENCE TO RELATED APPLICATION

This application is based upon and claims the benefit of priority of the prior Japanese Patent Application No. 2022-119065, filed on Jul. 26, 2022, the entire contents of which are incorporated herein by reference.

### FIELD

The embodiments discussed herein are related to a computer-readable recording medium storing an information processing program, an information processing method, and an information processing apparatus.

### BACKGROUND

For supervised learning in related art, a plurality of workers may share and perform annotation work on a plurality of pieces of data. In annotation work, labels are assigned to data. The data is, for example, source code. For example, in the annotation work, each line of the source code is assigned with a label corresponding to a processing content of the line.

International Publication Pamphlet No. WO 2020/049622 is disclosed as related art.

### SUMMARY

According to an aspect of the embodiments, a non-transitory computer-readable recording medium stores an information processing program for causing a computer to execute a process including: acquiring a plurality of pieces of source code; making an expansion of a function corresponding to a module in source code in a case in which a definition of the module is included in the source code and when the module is not included in a predetermined library, for each of the plurality of pieces of source code acquired; and specifying a group including two or more pieces of source code to be subjected to annotation work together among the plurality of pieces of source code, based on a result of comparing each of the plurality of pieces of source code after the expansion.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system;

FIG. 3 is a block diagram illustrating a hardware configuration example of an information processing apparatus;

FIG. 4 is a block diagram illustrating a functional configuration example of the information processing apparatus;

FIG. 5 is a block diagram illustrating a functional configuration example of the information processing system;

FIG. 6 is an explanatory diagram (first part) illustrating an example of converting source code;

FIG. 7 is an explanatory diagram (second part) illustrating an example of converting source code;

FIG. 8 is an explanatory diagram (third part) illustrating an example of converting source code;

FIG. 9 is an explanatory diagram (fourth part) illustrating an example of converting source code;

FIG. 10 is an explanatory diagram (fifth part) illustrating an example of converting source code;

FIG. 11 is an explanatory diagram (first part) illustrating an example in which a source code group is classified into groups as many as the number of workers;

FIG. 12 is an explanatory diagram (second part) illustrating an example in which a source code group is classified into groups as many as the number of workers;

FIG. 13 is an explanatory diagram (third part) illustrating an example in which a source code group is classified into groups as many as the number of workers;

FIG. 14 is an explanatory diagram (fourth part) illustrating an example in which a source code group is classified into groups as many as the number of workers;

FIG. 15 is an explanatory diagram illustrating an example in which a source code group is allocated to a plurality of workers;

FIG. 16 is an explanatory diagram illustrating an example of an effect of selecting a function to be expanded;

FIG. 17 is a flowchart illustrating an example of an overall processing procedure (first part);

FIG. 18 is a flowchart illustrating an example of an overall processing procedure (second part);

FIG. 19 is a flowchart illustrating an example of an overall processing procedure (third part); and

FIG. 20 is a flowchart illustrating an example of a conversion processing procedure.

### DESCRIPTION OF EMBODIMENTS

For example, a technique as follows may be cited as related art: to each of a plurality of graphs representing a processing structure of each of a plurality of pieces of source code, conceptual information specified from element information corresponding to each node in the graph is assigned as attribute information related to the node based on knowledge information.

However, in the related art, it is difficult to suppress an increase in a workload on a worker of annotation work. For example, in a case where a worker is in charge of annotation work for two or more pieces of source code that are not related to each other, the workload is likely to increase.

In one aspect, an object of the present disclosure is to reduce a workload on a worker of annotation work.

Hereinafter, embodiments of an information processing program, an information processing method, and an information processing apparatus according to the present disclosure are described in detail with reference to the drawings.

### Example of Information Processing Method According to Embodiment

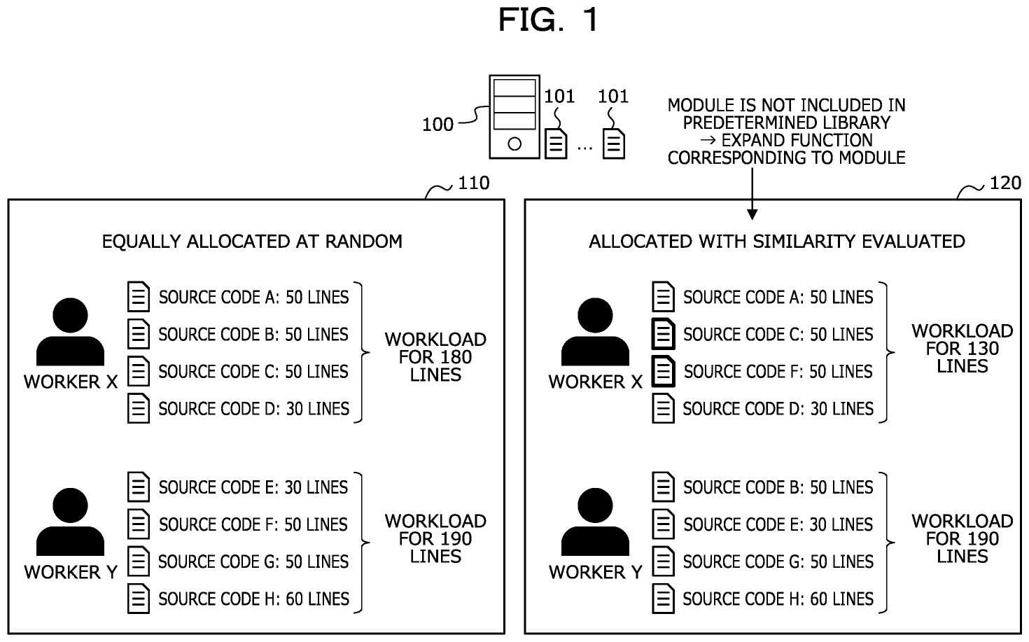

FIG. 1 is an explanatory diagram illustrating an example of an information processing method according to an embodiment. An information processing apparatus 100 is a computer configured to support annotation work. The information processing apparatus 100 is, for example, a server, a personal computer (PC), or the like.

For example, the annotation work is performed to generate training data to be used for supervised learning, and generates the training data by assigning labels to data. The data is, for example, source code. For example, the label is information that is assigned to each line of the source code and indicates an attribute corresponding to a processing content of the line.

When annotation work is performed on a plurality of pieces of source code, a plurality of workers may share and perform the annotation work on the plurality of pieces of source code in order to improve work efficiency of the annotation work on the plurality of pieces of source code.

As the number of pieces of source code to be labeled increases, a workload applied to each worker that shares and performs the annotation work is likely to increase, and thus it is desirable to suppress an increase in the workload on each of the workers.

However, with the related art, it is difficult to suppress the increase in the workload on each of the workers sharing and performing the annotation work.

For example, a method is conceivable in which a plurality of pieces of source code is equally allocated to each of the workers regardless of contents of source code, and each worker performs the annotation work on two or more pieces of source code allocated to the worker. For example, it is conceivable to equally allocate the plurality of pieces of source code to each of the workers at random.

According to this method, in some cases, two or more pieces of source code that are not related to each other are allocated to a worker, and the worker performs annotation work on the two or more pieces of source code that are not related to each other. In this case, the worker may not make use of a result, an experience, and the like obtained by performing the annotation work on any source code of the two or more pieces of source code allocated to the worker, at the time of performing the annotation work on another piece of source code. As a result, the worker independently performs the annotation work on each piece of source code. Accordingly, it is difficult to suppress the increase in the workload on the worker.

According to this method, there may be a case in which two or more pieces of source code including a pair of different pieces of source code related to each other are allocated to a worker by chance, and the worker performs annotation work on the two or more pieces of source code including the above-mentioned pair. In this case, the worker may not recognize which paired pieces of source code are related to each other. Because of this, the worker may not make use of a result, an experience, and the like obtained by performing the annotation work on any source code of the two or more pieces of source code allocated to the worker, at the time of performing the annotation work on another piece of source code. As a result, the worker independently performs the annotation work on each piece of source code. Accordingly, it is difficult to suppress the increase in the workload on the worker.

Of the plurality of pieces of source code, when two or more pieces of source code including a combination of different pieces of source code related to each other are allocated to the same worker, it is considered to be easy to suppress an increase in the workload on the worker.

On the other hand, by referring to International Publication Pamphlet No. WO 2020/049622 cited above, a method is conceivable in which a combination of different pieces of source code related to each other is specified based on an abstract syntax tree corresponding to each piece of source code, and two or more pieces of source code including the above combination are allocated to the same worker.

For example, based on assumed knowledge information, each piece of source code is converted into an abstract syntax tree, and the converted abstract syntax trees are compared with each other to specify a combination of different pieces of source code related to each other. The knowledge information indicates, for example, elements such as words appearing in the source code, conceptual information that summarizes the elements, and the like.

Even with this method, it is difficult to suppress an increase in the workload on the worker in some case. For example, a processing content to be called by a function in source code may not be appropriately considered, which makes it difficult to specify a combination of different pieces of source code related to each other. For example, a definition statement for naming a module in source code may not be appropriately considered, which makes it difficult to specify a combination of different pieces of source code related to each other. For example, instantiation of a class in source code may not be appropriately considered, which makes it difficult to specify a combination of different pieces of source code related to each other.

For these reasons, with this method, it is difficult to specify a combination of different pieces of source code related to each other, and thus it is difficult to allocate two or more pieces of source code including the above combination to the same worker. On the other hand, in a case where source code is converted into an abstract syntax tree in consideration of processing contents to be called by all functions in the source code, there arises a problem that a processing load on the conversion is increased.

In the present embodiment, an information processing method capable of reducing a workload applied to a worker for performing annotation work will be described. In the description given below, an abstract syntax tree is referred to as an “AST” in some case.

(1-1) An information processing apparatus 100 acquires a plurality of pieces of source code 101, in FIG. 1. For example, the information processing apparatus 100 acquires the plurality of pieces of source code 101 by receiving the source code from another computer. For example, the information processing apparatus 100 may acquire the plurality of pieces of source code 101 by accepting input the source code based on an operational input by a user of the information processing apparatus 100. For example, the information processing apparatus 100 may acquire the plurality of pieces of source code 101 by reading the source code from a recording medium coupled to the information processing apparatus 100.

(1-2) The information processing apparatus 100 judges whether each of the plurality of pieces of source code 101 acquired includes a definition of a module in the source code 101. A definition of a module is, for example, an import statement. A definition of a module is, for example, to read a module. A definition of a module may include, for example, naming of a module. When the source code 101 includes a definition of a module, the information processing apparatus 100 judges whether the module is included in a predetermined library. The predetermined library does not define a module developed by a developer of the source code 101 but defines a module being made public.

In the case where a definition of a module is included in the source code 101 and the module is not included in the predetermined library, the information processing apparatus 100 searches for a function corresponding to the module in the source code 101. A function corresponding to the module is a function defined in the module. The information processing apparatus 100 expands the searched function in the source code 101. The expansion of a function is to replace the function with a processing content itself called by the function. For example, the information processing apparatus 100 expands functions included in at least one piece of source code 101 among the plurality of pieces of source code 101. As a result, the information processing apparatus 100 may evaluate similarity between the pieces of source code 101 in consideration of the processing contents called by the functions in the pieces of source code 101.

(1-3) The information processing apparatus 100 specifies a group including two or more pieces of source code 101 to be subjected to annotation work together among the plurality of pieces of source code 101, based on a result of comparing each of the plurality of pieces of source code 101 with each other after expansion. For example, the plurality of pieces of source code 101 after expansion is the plurality of pieces of source code 101 after expanding functions included in at least one piece of source code 101.

For example, the information processing apparatus 100 specifies a combination of two or more different pieces of source code 101 having similar processing contents among the plurality of pieces of source code 101 based on a result of comparing each of the plurality of pieces of source code 101 with each other after expansion. For example, the information processing apparatus 100 specifies a group including the specified combination by classifying the plurality of pieces of source code 101 into a plurality of groups in such a manner that the specified combination is included in the same group.

For example, the information processing apparatus 100 generates an abstract syntax tree corresponding to each of the plurality of pieces of source code 101 after expansion. For example, the information processing apparatus 100 specifies a combination of two or more different abstract syntax trees including subtrees having the same content among the generated abstract syntax trees. For example, the information processing apparatus 100 specifies a group including the source code 101 corresponding to each abstract syntax tree of the specified combination. With this, the information processing apparatus 100 may evaluate the similarity between the pieces of source code 101 and classify two or more pieces of source code 101 related to each other into the same group.

(1-4) The information processing apparatus 100 outputs a group including two or more pieces of source code 101 in such a manner that the worker may recognize the correspondence between the two or more pieces of source code 101 to be subjected to annotation work together, and the worker is capable of referring to the group. As a result, the information processing apparatus 100 may suppress the increase in the workload on the worker who performs the annotation work.

For example, the information processing apparatus 100 enables the worker to take charge of a group including two or more pieces of source code 101 related to each other, and enables the worker to perform the annotation work. For example, the information processing apparatus 100 may enable the worker to perform the annotation work while the worker recognizing two or more pieces of source code 101 related to each other.

As a result, for example, the information processing apparatus 100 makes it easy for the worker to make use of a result, experience, and the like obtained by performing the annotation work on any source code 101, at the time of performing the annotation work on another piece of source code 101. Accordingly, the information processing apparatus 100 may suppress the increase in the workload on the worker who performs the annotation work, for example.

By appropriately considering a processing content called by a function in the source code 101, the information processing apparatus 100 may make it possible to specify a group including two or more pieces of source code 101 related to each other with high accuracy. Because of this, the information processing apparatus 100 may make it easy to suppress the increase in the workload on the worker who performs the annotation work.

For example, in FIG. 1, a situation will be described in which source code A to source code H are present, the source code C and source code F are related to each other, and workers X and Y to perform annotation work are present. Each of the pieces of source code A, B, C, F, and G is assumed to be source code of 50 lines. Each of the source code D and source code E is assumed to be source code of 30 lines. The source code H is assumed to be source code of 60 lines.

In a case where the source code A to source code H are equally allocated to the workers X and Y at random, the source code C and source code F may respectively be allocated to different workers. For example, as indicated by a reference numeral 110, the source code A to source code D are allocated to the worker X, and the source code E to source code H are allocated to the worker Y. As a result, a workload of 180 lines is applied to the worker X, and a workload of 190 lines is applied to the worker Y.

On the other hand, the information processing apparatus 100 may specify the source code C and source code F to make it possible to allocate the source code C and source code F to the same worker X. For example, as indicated by a reference numeral 120, the pieces of source code A, C, D, and F are allocated to the worker X, and the pieces of source code B, E, G, and H are allocated to the worker Y. With this, the information processing apparatus 100 may enable the worker X to make use of an experience and a result obtained by performing the annotation work on the source code C, at the time of performing the annotation work on the source code F.

For this reason, the worker X may cut or reduce a workload applied when performing the annotation work on the source code F. For example, the worker X may cause the workload applied when performing the annotation work on the source code F to be 0. As a result, a workload of 130 lines is applied to the worker X, and a workload of 190 lines is applied to the worker Y. As described above, the information processing apparatus 100 is capable of suppressing the increase in the workload applied to the worker X.

Although a case where the information processing apparatus 100 operates alone has been described, the disclosure is not limited thereto. For example, there may be a case where the information processing apparatus 100 cooperates with another computer. For example, there may be a case where a plurality of computers cooperates with each other to implement a function as the information processing apparatus 100. For example, there may be a case in which the function as the information processing apparatus 100 is implemented on a cloud.

### Example of Information Processing System 200

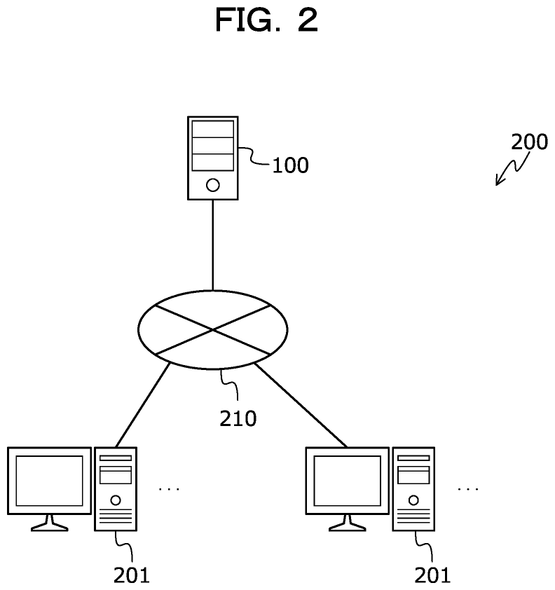

Next, an example of an information processing system 200, to which the information processing apparatus 100 illustrated in FIG. 1 is applied, will be described with reference to FIG. 2.

FIG. 2 is an explanatory diagram illustrating an example of the information processing system 200. Referring to FIG. 2, the information processing system 200 includes the information processing apparatus 100 and client apparatuses 201.

In the information processing system 200, the information processing apparatus 100 and the client apparatuses 201 are coupled to each other via a wired or wireless network 210. Examples of the network 210 include a local area network (LAN), a wide area network (WAN), and the Internet.

The information processing apparatus 100 is a computer configured to allocate a plurality of pieces of source code to a plurality of workers and support annotation work by the workers. The workers are persons to perform annotation work. The information processing apparatus 100 acquires a plurality of pieces of source code.

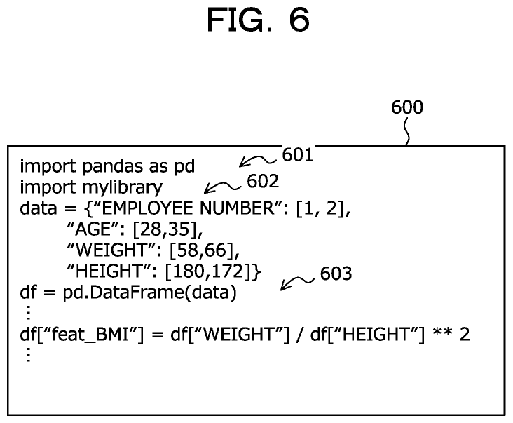

The information processing apparatus 100, after processing each of the plurality of pieces of source code acquired, converts each piece of source code into an AST corresponding to the source code. For example, the above processing may include expansion of a function. For example, the processing may include name resolution of a module. For example, the processing includes canceling the replacement of a module name. For example, the processing may include integration of instantiation of a class and calling of the instance. For example, the processing includes converting an instance call using the name of the class into an instance call using a module name. Specific examples of the processing will be described below with reference to FIGS. 6 to 16, for example.

By comparing the converted ASTs with each other, the information processing apparatus 100 specifies a combination of pieces of source code corresponding to each other among the plurality of pieces of source code. The expression of corresponding to each other refers to the processing contents being related to each other, for example. The information processing apparatus 100 classifies a plurality of pieces of source code into a plurality of groups in such a manner that the specified combination is included in the same group. The plurality of groups refers to, for example, groups as many as the number of workers. By allocating the plurality of classified groups respectively to different workers, the information processing apparatus 100 allocates the plurality of pieces of source code to the plurality of workers.

The information processing apparatus 100 outputs the group allocated to each of the plurality of workers in such a manner that the worker may refer to the group. The information processing apparatus 100 may output, along with the group, information specifying a combination of pieces of source code included in the group and corresponding to each other. For example, the information processing apparatus 100 transmits the group allocated to each of the plurality of workers to the client apparatus 201 corresponding to the worker. For example, the information processing apparatus 100 transmits the group allocated to each of the plurality of workers and the information specifying the combination of pieces of source code included in the group and corresponding to each other, to the client apparatus 201 corresponding to the worker.

With this, the information processing apparatus 100 enables the client apparatus 201 to output the source code that is allocated to the worker and is to be subjected to the annotation work. For example, the information processing apparatus 100 may enable the client apparatus 201 to output a combination of pieces of source code corresponding to each other. The information processing apparatus 100 may request the worker to perform annotation work via the client apparatus 201, and may reduce the workload on the worker. The information processing apparatus 100 is, for example, a server, a PC, or the like.

The client apparatus 201 is a computer used by workers to perform annotation work. For example, the client apparatus 201 receives the group from the information processing apparatus 100. The client apparatus 201 may receive, along with the group, the information specifying the combination of pieces of source code included in the group and corresponding to each other from the information processing apparatus 100. The client apparatus 201 outputs the group to be referred to by the worker. The client apparatus 201 may output, along with the group, the information specifying the combination of pieces of source code included in the group and corresponding to each other in such a manner that the information may be referred to by the worker.

With this, the client apparatus 201 may enable the worker to recognize the source code that is allocated to the worker and is to be subjected to the annotation work. The client apparatus 201 may enable the worker to recognize the combination of pieces of source code corresponding to each other. The client apparatus 201 may reduce the workload applied to the worker. The client apparatus 201 is, for example, a PC, a tablet terminal, a smartphone, or the like.

Although the case where the information processing apparatus 100 is an apparatus different from the client apparatus 201 has been described, the disclosure is not limited thereto. For example, there may be a case where the information processing apparatus 100 has a function as the client apparatus 201 and is capable of operating as the client apparatus 201.

### Hardware Configuration Example of Information Processing Apparatus 100

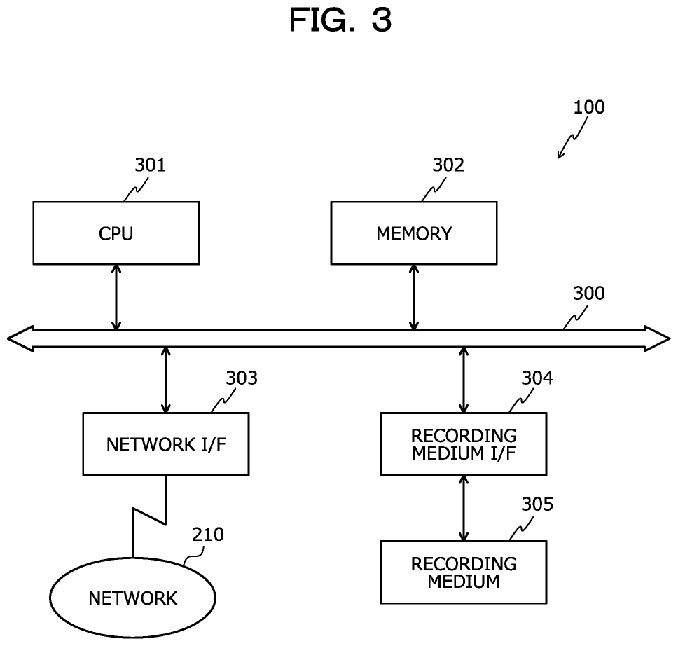

Next, a hardware configuration example of the information processing apparatus 100 will be described with reference to FIG. 3.

FIG. 3 is a block diagram illustrating a hardware configuration example of the information processing apparatus 100. In FIG. 3, the information processing apparatus 100 includes a central processing unit (CPU) 301, a memory 302, a network interface (I/F) 303, a recording medium I/F 304, and a recording medium 305. These components are coupled to one another through a bus 300.

The CPU 301 controls the entire information processing apparatus 100. The memory 302 includes, for example, a read-only memory (ROM), a random-access memory (RAM), a flash ROM, and the like. For example, the flash ROM or the ROM stores various programs, and the RAM is used as a work area for the CPU 301. The programs stored in the memory 302, when loaded in the CPU 301, cause the CPU 301 to execute coded processing.

The network I/F 303 is coupled to the network 210 through a communication line, and is coupled to another computer via the network 210. The network I/F 303 manages the interface between the network 210 and the interior to control input and output of data from and to another computer. The network I/F 303 is, for example, a modem, a LAN adapter, or the like.

The recording medium I/F 304 controls reading and writing of data from and to the recording medium 305 under the control of the CPU 301. The recording medium I/F 304 is, for example, a disk drive, a solid-state drive (SSD), a Universal Serial Bus (USB) port, or the like. The recording medium 305 is a non-volatile memory that stores data written under the control of the recording medium I/F 304. The recording medium 305 is, for example, a disk, a semiconductor memory, a USB memory, or the like. The recording medium 305 may be removably attached to the information processing apparatus 100.

In addition to the components described above, the information processing apparatus 100 may include, for example, a keyboard, a mouse, a display, a printer, a scanner, a microphone, a speaker, and the like. The information processing apparatus 100 may include a plurality of the recording medium I/Fs 304 and a plurality of the recording media 305. The information processing apparatus 100 may be allowed not to include the recording medium I/F 304 and the recording medium 305.

### Hardware Configuration Example of Client Apparatus 201

For example, a hardware configuration example of the client apparatus 201 is substantially the same as the hardware configuration example of the information processing apparatus 100 illustrated in FIG. 3. Therefore, description thereof is omitted herein.

### Functional Configuration Example of Information Processing Apparatus 100

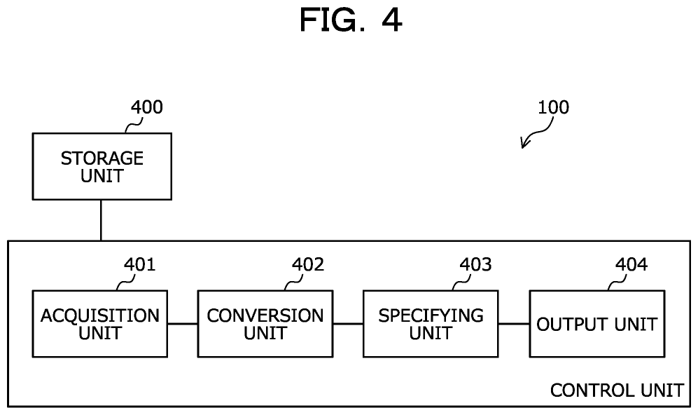

Next, a functional configuration example of the information processing apparatus 100 will be described with reference to FIG. 4.

FIG. 4 is a block diagram illustrating a functional configuration example of the information processing apparatus 100. The information processing apparatus 100 includes a storage unit 400, an acquisition unit 401, a conversion unit 402, a specifying unit 403, and an output unit 404.

The storage unit 400 is implemented by, for example, a storage area such as the memory 302 or the recording medium 305 illustrated in FIG. 3. Hereinafter, a case where the storage unit 400 is included in the information processing apparatus 100 will be described, but the disclosure is not limited thereto. For example, there may be a case where the storage unit 400 is included in an apparatus different from the information processing apparatus 100 and the information processing apparatus 100 is allowed to refer to information stored in the storage unit 400.

The acquisition unit 401 to the output unit 404 function as an example of a control unit. For example, functions of the acquisition unit 401 to the output unit 404 are enabled by causing the CPU 301 to execute programs stored in the storage area such as the memory 302 or the recording medium 305 illustrated in FIG. 3 or by using the network I/F 303. A processing result by each functional unit is stored in, for example, a storage area such as the memory 302 or the recording medium 305 illustrated in FIG. 3.

The storage unit 400 stores various kinds of information to be referred to or updated in the processing of each functional unit. A plurality of pieces of source code to be subjected to annotation work is stored therein. For example, the source code includes a definition of a module. A definition of a module defines reading of the module with respect to the source code. For example, the definition of a module may include a command statement to name the module and replace the original name of the module with a designated name. For example, the definition of a module is an import statement of the module.

For example, source code includes a function. For example, the source code includes a function regarding a module. A function regarding a module is, for example, a function defined in the module. For example, the source code includes a definition of a class. A definition of a class includes, for example, naming of the class. For example, the source code includes a definition of a class regarding the module. For example, the source code includes an instance call using the name of the class. For example, the source code is acquired by the acquisition unit 401.

The acquisition unit 401 acquires various kinds of information for use in the processing performed by each of the functional units. The acquisition unit 401 stores the acquired various kinds of information in the storage unit 400 or outputs the acquired various kinds of information to each of the functional units. The acquisition unit 401 may output the various kinds of information stored in the storage unit 400 to each of the functional units. For example, the acquisition unit 401 acquires various kinds of information based on an operational input by the user of the information processing apparatus 100. For example, the acquisition unit 401 may receive various kinds of information from an apparatus different from the information processing apparatus 100.

For example, the acquisition unit 401 acquires a plurality of pieces of source code to be subjected to annotation work. For example, the acquisition unit 401 acquires the plurality of pieces of source code by receiving the source code from another computer. For example, the acquisition unit 401 acquires the plurality of pieces of source code by receiving input of the plurality of pieces of source code. For example, the acquisition unit 401 may acquire the plurality of pieces of source code by acquiring an allocation request including the plurality of pieces of source code.

The acquisition unit 401 may receive a start trigger to start the processing of any of the functional units. For example, the start trigger indicates a predetermined operational input being performed by the user of the information processing apparatus 100. For example, the start trigger may indicate predetermined information being received from another computer. For example, the start trigger may also indicate predetermined information being output by any of the functional units. For example, the acquisition unit 401 receives information telling the acquisition of a plurality of pieces of source code as a start trigger to start the processing of the conversion unit 402 and the specifying unit 403.

The conversion unit 402 processes at least any source code of the plurality of pieces of source code. For example, the conversion unit 402 processes the source code by expanding a function in the source code. For example, the expansion is to replace the description of a function call statement with the description of a processing content of the function called by the function call statement.

For example, the conversion unit 402 judges whether each of the plurality of pieces of source code acquired includes a definition of a module in the source code. The definition of a module is, for example, an import statement of the module. For example, the conversion unit 402 judges whether each of the plurality of pieces of source code includes a module import statement in the source code.

When the source code includes a definition of a module, for example, the conversion unit 402 judges whether the module is included in a predetermined library. The predetermined library is, for example, a library made public by a vendor. The vendor is, for example, a vendor of a programming language. For example, the predetermined library does not define a module developed by a developer of the source code but defines a module made public by the vendor.

For example, in the case where the source code includes a definition of a module, the conversion unit 402 judges that the module is not developed by the developer when the module is included in the predetermined library. For example, in the case where the source code includes a definition of a module, the conversion unit 402 judges that the module is developed by the developer when the module is not included in the predetermined library.

For example, in the case where a definition of a module is included in the source code and the module is not included in the predetermined library, the conversion unit 402 expands a function corresponding to the module in the source code. With this, the conversion unit 402 makes it possible to consider the processing content of the function and makes it easy to specify a combination of pieces of source code corresponding to each other when the pieces of source code are compared with each other in the specifying unit 403. The conversion unit 402 may selectively expand some functions included in the source code, and may suppress an increase in processing load during the processing. The conversion unit 402 may suppress an increase in size of the AST corresponding to the source code.

For example, the conversion unit 402 judges whether each of the plurality of pieces of source code includes a definition of a module including replacement of the name of the module in the source code. For example, the conversion unit 402 judges whether each of the plurality of pieces of source code includes an import statement of a module including replacement of the name of the module in the source code.

For example, in a case where a definition of a module including replacement of the name of the module is included in source code, the conversion unit 402 processes the source code by canceling the replacement of the name of the module in the source code. For example, the conversion unit 402 converts the post-replacement name of the module included in the source code into the pre-replacement name of the module. With this, the conversion unit 402 makes it possible to consider the replacement of the module name and makes it easy to specify a combination of pieces of source code corresponding to each other when the pieces of source code are compared with each other in the specifying unit 403.

For example, the conversion unit 402 judges whether each of the plurality of pieces of source code includes a definition of a class. The definition of a class includes, for example, instantiation of a class and includes naming of the class. For example, when the source code includes a definition of a class, the conversion unit 402 searches for an instance call statement using the name of the class in the source code.

For example, the conversion unit 402 processes the source code by integrating the instance call statement using the searched class name with the definition of the class in the source code. With this, the conversion unit 402 makes it possible to consider the instance call of the class and makes it easy to specify a combination of pieces of source code corresponding to each other when the pieces of source code are compared with each other in the specifying unit 403.

The specifying unit 403 specifies a combination of pieces of source code corresponding to each other, and specifies a group of pieces of source code including the specified combination. A combination is a set of two or more pieces of source code to be subjected together to annotation work.

For example, the specifying unit 403 specifies a combination of two or more pieces of source code to be subjected together to annotation work among the plurality of pieces of source code based on a result of comparison between each of the plurality of pieces of source code after being processed. For example, the specifying unit 403 specifies a group including the specified combination of two or more pieces of source code.

For example, the specifying unit 403 generates an abstract syntax tree corresponding to each of the plurality of pieces of source code having been processed. For example, the specifying unit 403 specifies a combination of pieces of source code corresponding to each of two or more different abstract syntax trees including subtrees having the same content among the generated abstract syntax trees. For example, the specifying unit 403 specifies a group including the specified combination.

With this, the specifying unit 403 may specify a combination of pieces of source code corresponding to each other and having a relatively high probability that the work content is common regarding annotation work, and may set the combination as a target to be subjected together to annotation work. Because of this, the specifying unit 403 may specify a combination of pieces of source code considered to be preferably allocated to the same worker, and may suppress an increase in the workload on the worker.

For example, when a variable name is included in each of the plurality of pieces of source code after being processed, the specifying unit 403 generates an abstract syntax tree corresponding to the source code in which the variable name is replaced with mask data. For example, the specifying unit 403 specifies a combination of pieces of source code corresponding to each of two or more different abstract syntax trees including subtrees having the same content among the generated abstract syntax trees. For example, the specifying unit 403 specifies a group including the specified combination.

With this, the specifying unit 403 may specify a combination of pieces of source code corresponding to each other and having a relatively high probability that the work content is common regarding annotation work, and may set the combination as a target to be subjected together to annotation work. Because of this, the specifying unit 403 may specify a combination of pieces of source code considered to be preferably allocated to the same worker, and may suppress an increase in the workload on the worker.

For example, the specifying unit 403 specifies a combination of pieces of source code corresponding to each of two or more different abstract syntax trees including subtrees representing the same formula structure among the generated abstract syntax trees. For example, the specifying unit 403 specifies a group including the specified combination.

With this, the specifying unit 403 may specify a combination of pieces of source code corresponding to each other and having a relatively high probability that the work content is common regarding annotation work, and may set the combination as a target to be subjected together to annotation work. Because of this, the specifying unit 403 may specify a combination of pieces of source code considered to be preferably allocated to the same worker, and may suppress an increase in the workload on the worker.

The output unit 404 outputs a processing result of at least any of the functional units. For example, the output form is display on a display, print output to a printer, transmission to an external apparatus through the network I/F 303, or storage in a storage area such as the memory 302 or the recording medium 305. Thus, the output unit 404 is capable of notifying a user of the information processing apparatus 100 of the processing result of at least any of the functional units, thereby improving the convenience of the information processing apparatus 100.

The output unit 404 outputs information indicating the specified group. For example, the output unit 404 transmits information indicating the specified group to the client apparatus 201. With this, the output unit 404 may allocate the specified group to the worker, and may cause the worker to perform annotation work. The output unit 404 may cause the same worker to perform the annotation work on a combination of two or more pieces of source code corresponding to each other, and thus may suppress an increase in the workload on the worker.

The output unit 404 may output information indicating the specified group together with information that makes it possible to specify the combination of two or more pieces of source code corresponding to each other. By doing the above, the output unit 404 makes it possible for the worker to recognize the combination of two or more pieces of source code corresponding to each other, makes it possible for the worker to easily perform the annotation work, and makes it possible to suppress the increase in the workload on the worker.

Although the case where the information processing apparatus 100 includes the acquisition unit 401, the conversion unit 402, the specifying unit 403, and the output unit 404 has been described, the disclosure is not limited thereto. For example, the information processing apparatus 100 may not include the conversion unit 402 in some case. For example, the information processing apparatus 100 may communicate with another computer including the conversion unit 402, and the conversion unit 402 may be used via another computer in some case.

### Functional Configuration Example of Information Processing System 200

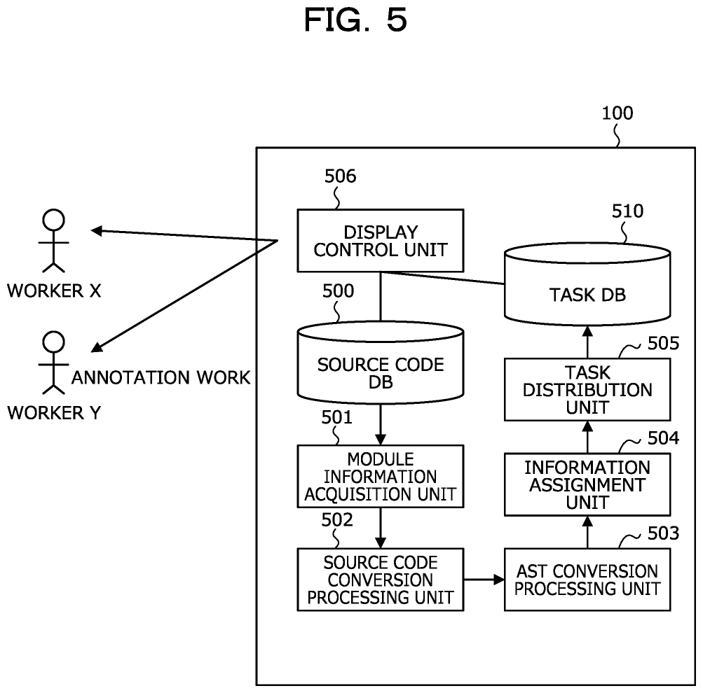

Next, a functional configuration example of the information processing system 200 will be described with reference to FIG. 5.

FIG. 5 is a block diagram illustrating a functional configuration example of the information processing system 200. In FIG. 5, the information processing apparatus 100 includes a source code database (DB) 500 and a task DB 510. The source code DB 500 stores source code. The task DB 510 stores a group of source code.

The information processing apparatus 100 includes a module information acquisition unit 501, a source code conversion processing unit 502, an AST conversion processing unit 503, an information assignment unit 504, a task distribution unit 505, and a display control unit 506. The module information acquisition unit 501, the source code conversion processing unit 502, the AST conversion processing unit 503, the information assignment unit 504, the task distribution unit 505, and the display control unit 506 implement the respective functional units illustrated in FIG. 4.

The module information acquisition unit 501 acquires a target source code group and module information. The module information does not include an identifier for identifying a module developed by a developer of the source code group, but includes an identifier for identifying a module developed by a vendor.

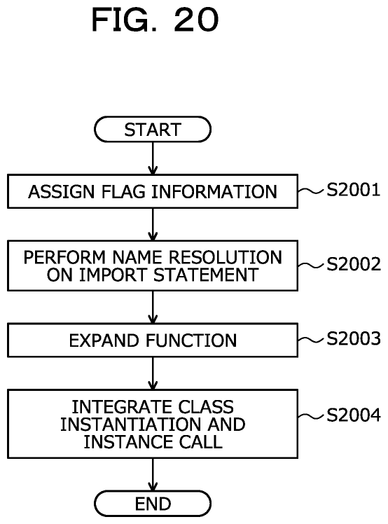

The source code conversion processing unit 502 performs conversion processing on the target source code group with reference to the module information, thereby processing each piece of source code in the target source code group. A specific example of the conversion processing will be described later with reference to FIG. 20.

For example, when a function corresponding to a module developed by the developer is included in each piece of source code, the source code conversion processing unit 502 expands the function corresponding to the module in the source code. For example, when a module name replacement command statement is included in each piece of source code, the source code conversion processing unit 502 cancels the replacement of the module name in the source code.

For example, when a command statement for instantiation of a class and a command statement for calling the instance are separately included in the respective pieces of source code, the source code conversion processing unit 502 integrates the respective command statements. With this, the source code conversion processing unit 502 may standardize the description format of each piece of source code in the target source code group to make it easy to compare the processing contents between pieces of source code.

The AST conversion processing unit 503 converts each piece of source code of the target source code group having experienced the conversion processing, into an AST corresponding to the source code. By comparing the ASTs corresponding to the respective pieces of source code, the information assignment unit 504 specifies a combination of pieces of source code corresponding to each other. For example, when the same subtree is included in an ASTi corresponding to source code i and an ASTj corresponding to source code j, the information assignment unit 504 judges that the source code i and the source code j correspond to each other.

For example, the information assignment unit 504 may mask an element regarding a variable name in the AST corresponding to each piece of source code. The masking is, for example, a scheme to treat different variable names by replacing them with the same dummy variable name. The masking may be, for example, a scheme to remove a target node or to remove a subtree below the target node. The target node is, for example, a node of an element regarding a variable name. For example, when the same subtree is included in an ASTi after being masked corresponding to source code i and an ASTj after being masked corresponding to source code j, the information assignment unit 504 may judge that the source code i and the source code j correspond to each other.

For example, when subtrees representing the same formula structure are respectively included in an ASTi corresponding to source code i and an ASTj corresponding to source code j, the information assignment unit 504 may judge that the source code i and the source code j correspond to each other. This makes it possible for the information assignment unit 504 to specify a combination of pieces of source code to be preferably allocated to the same worker and subjected to the annotation work performed by the same worker.

The task distribution unit 505 classifies a target source code group into groups as many as the number of workers in such a manner that the specified combination of pieces of source code is included in the same group. The task distribution unit 505 stores the groups as many as the number of workers in the task DB 510. For example, the task distribution unit 505 may store, in the task DB 510, as many groups as the number of workers being associated with information that makes it possible to specify the combinations of pieces of source code included in the groups and corresponding to each other. With this, the task distribution unit 505 may specify the group of pieces of source code to be allocated to each worker, and may allocate the source code to each worker.

The display control unit 506 corresponds to an annotation tool. By referring to the task DB 510, the display control unit 506 transmits the group of pieces of source code allocated to each worker to the client apparatus 201 corresponding to the worker. For example, the display control unit 506 may transmit the group of pieces of source code allocated to each worker being associated with information that makes it possible to specify the combination of pieces of source code included in the group and corresponding to each other, to the client apparatus 201 corresponding to the worker.

With this, the display control unit 506 may enable each worker to perform annotation work on the group of pieces of source code allocated to the worker. The display control unit 506 may enable the same worker to perform annotation work on the combination of pieces of source code corresponding to each other. For this reason, the display control unit 506 may suppress an increase in the workload on the worker to perform the annotation work.

Although the case where the task distribution unit 505 classifies the target source code group into groups as many as the number of workers has been described, the disclosure is not limited thereto. For example, there may be a case where the task distribution unit 505 classifies the target source code group into a larger number of groups than the number of workers. In this case, the task distribution unit 505 allocates two or more groups to any of the workers.

### Operation Example of Information Processing Apparatus 100

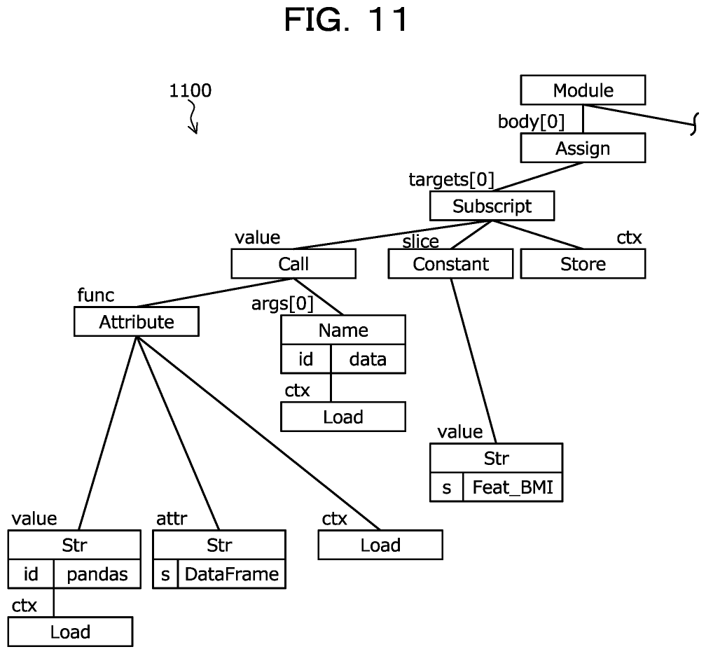

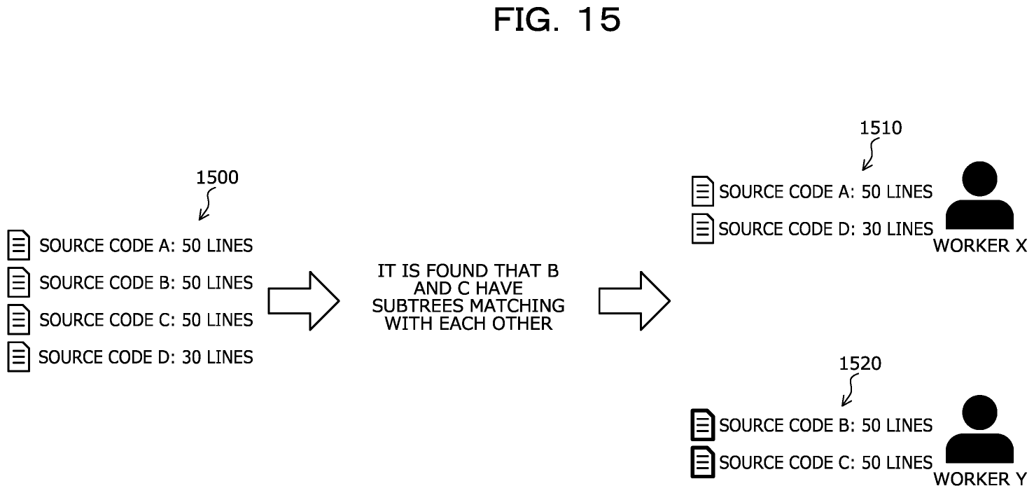

Next, an operation example of the information processing apparatus 100 will be described with reference to FIGS. 6 to 16. First, an example in which the information processing apparatus 100 converts source code will be described with reference to FIGS. 6 to 10. Then, an example in which the information processing apparatus 100 classifies a source code group into groups as many as the number of workers based on the converted source code will be described with reference to FIGS. 11 to 14. Thereafter, an example in which the information processing apparatus 100 outputs a group will be described with reference to FIG. 15.

FIGS. 6 to 10 are explanatory diagrams illustrating an example of converting source code. In FIG. 6, it is assumed that the information processing apparatus 100 has acquired a source code group. The information processing apparatus 100 converts source code included in the source code group. Here, a case where the information processing apparatus 100 takes source code 600 included in the source code group as a processing target will be described.

The information processing apparatus 100 searches for a module import statement in the source code 600 to judge whether the module import statement is included in the source code 600. In an example in FIG. 6, the information processing apparatus 100 finds module import statements 601 and 602, and judges that the module import statements 601 and 602 are included in the source code 600.

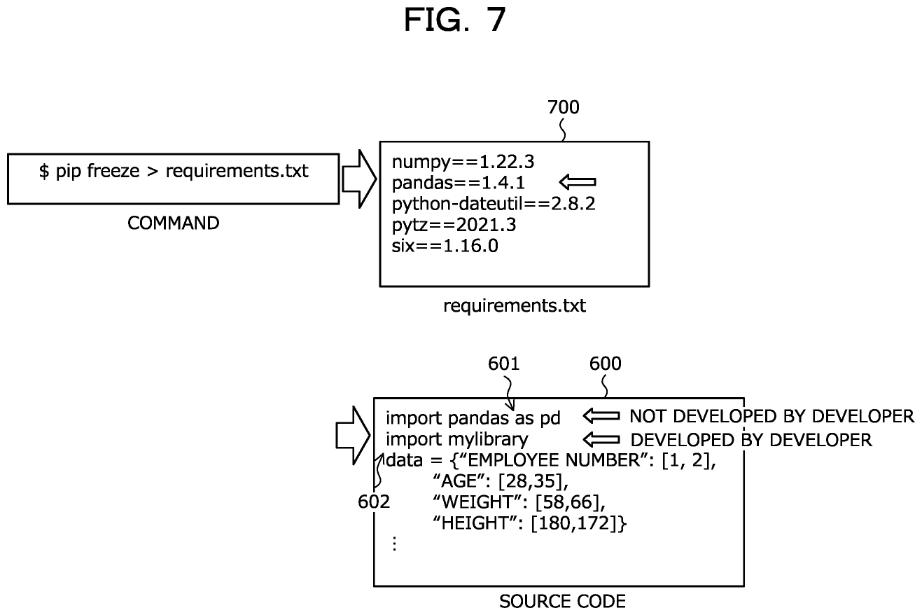

The information processing apparatus 100 judges whether the searched module import statements 601 and 602 are import statements of modules developed by a developer. The developer is, for example, a creator who has created the source code 600. Referring to description in FIG. 7, an example in which the information processing apparatus 100 judges whether the module import statement is an import statement of a module developed by a developer will be described.

In FIG. 7, the information processing apparatus 100 acquires module information. The module information does not include an identifier for identifying a module developed by a developer of the source code group, but includes an identifier for identifying a module developed by a vendor. The information processing apparatus 100 judges whether the searched module import statements 601 and 602 are import statements of modules developed by the developer with reference to the module information.

In the example in FIG. 7, the information processing apparatus 100 executes a pip freeze command in the Python package management tool to output a list of installed libraries to a requirements.txt file, for example. The information processing apparatus 100 uses the requirements.txt file as the module information.

For example, the information processing apparatus 100 searches the requirements.txt file for the module names described in the import statements 601 and 602 of the searched modules. For example, the information processing apparatus 100 judges whether the module import statements 601 and 602 are import statements of the modules developed by the developer based on a result of searching for the module names.

In the example in FIG. 7, it is assumed that the information processing apparatus 100 has acquired a file 700 as the requirements.txt file, for example. For example, since the module name “pandas” of the import statement 601 is found in the file 700, the information processing apparatus 100 judges that the import statement 601 is an import statement of the module that is not developed by the developer. On the other hand, since the module name “mylibrary” of the import statement 602 is not found in the file 700, the information processing apparatus 100 judges that the import statement 602 is an import statement of the module developed by the developer, for example.

Returning to the description in FIG. 6, the information processing apparatus 100 judges whether there is a module name replacement in the module import statements included in the source code 600. In the example in FIG. 6, the information processing apparatus 100 judges that there is a module name replacement in which the module name “pandas” is replaced with the module name “pd” in the module import statement 601. The information processing apparatus 100 judges that there is no module name replacement in the module import statement 602.

In the case where there is a module name replacement in a module import statement included in the source code 600, the information processing apparatus 100 cancels the module name replacement. In the example in FIG. 6, since there is a module name replacement in which the module name “pandas” is replaced with the module name “pd” in the module import statement 601, the information processing apparatus 100 deletes a portion for replacing the module name from the module import statement 601.

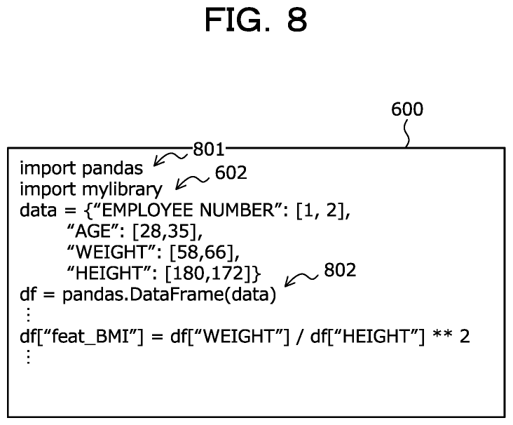

Since the replacement of the module name “pandas” with the module name “pd” exists in the module import statement 601, the information processing apparatus 100 returns the module name “pd” included in a command statement 603 back to the module name “pandas”. Referring to description in FIG. 8, an example of the source code 600 after the information processing apparatus 100 has canceled the module name replacement will be described.

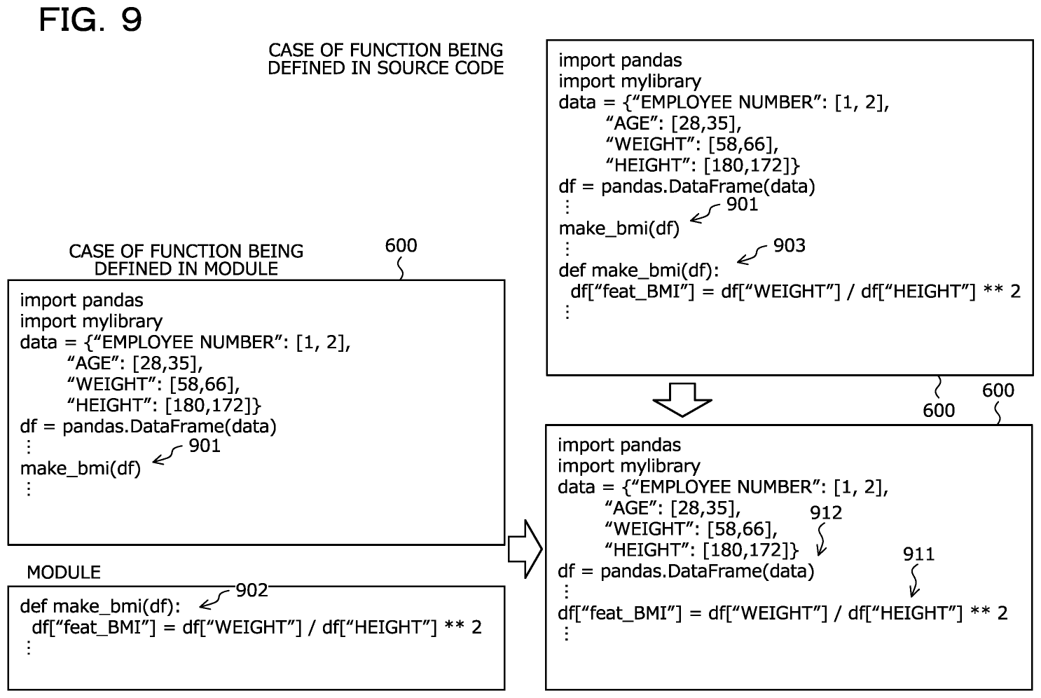

As illustrated in FIG. 8, for example, the information processing apparatus 100 updates the source code 600 to produce a state in which the import statement 601 is converted into an import statement 801 with no module name replacement, and the command statement 603 is converted into a command statement 802. The import statement 602 is not updated in the source code 600. Next, the description continues with reference to FIG. 9.

In FIG. 9, the information processing apparatus 100 expands a function regarding a module developed by the developer in the source code 600. In an example in FIG. 9, since the source code 600 includes a function call statement 901 regarding the module “mylibrary” developed by the developer, the information processing apparatus 100 expands the function call statement 901.

As indicated by a reference numeral 900 in FIG. 9, for example, the information processing apparatus 100 updates the source code 600 by converting the function call statement 901 into description 902 representing a processing content of the function defined in the module “mylibrary”.

For example, as indicated by a reference numeral 910 in FIG. 9, there may be a case where the source code 600 including the function call statement 901 includes description 903 directly representing the processing content of the function without using a module. In this case, the information processing apparatus 100 converts the function call statement 901 into the description 903 representing the processing content of the function, and deletes the original description 903, thereby updating the source code 600.

Both the state after the update of the source code 600 indicated by the reference numeral 900 and the state after the update of the source code 600 indicated by the reference numeral 910 are the state of the source code 600 indicated by a reference numeral 920. The state after the update of the source code 600 indicated by the reference numeral 900 includes, for example, description 911 corresponding to the description 902 representing the processing content of the function, instead of the function call statement 901.

On the other hand, the state after the update of the source code 600 indicated by the reference numeral 910 includes, for example, the description 911 representing the processing content of the function, instead of a combination of the function call statement 901 and the original description 903. As described above, the information processing apparatus 100 may process pieces of source code having the same processing content in different forms into the same source code.

In a case where the instantiation of a class and the instance call are separately present in the source code 600, the information processing apparatus 100 integrates the instantiation of the class and the instance call. In the example in FIG. 9, the information processing apparatus 100 judges that the source code 600 includes the command statement 912 for class instantiation and the description 911 including the instance call.

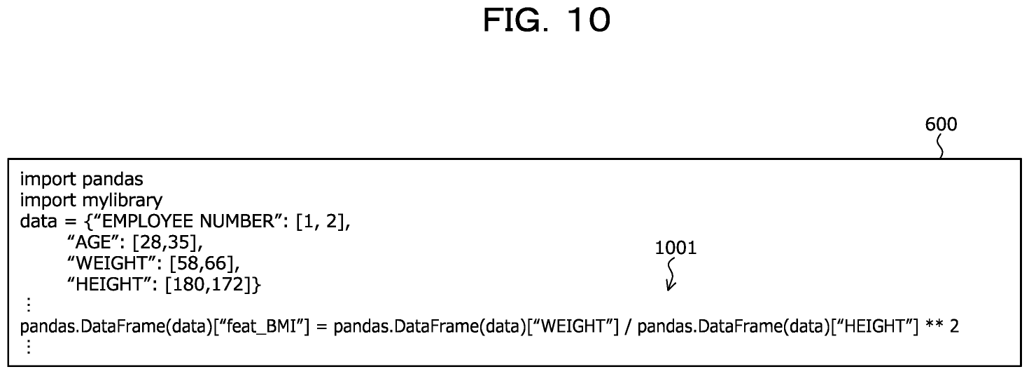

Because of this, the information processing apparatus 100 integrates the command statement 912 for class instantiation and the description 911 including the instance call. Referring to description in FIG. 10, an example of the source code 600 after the information processing apparatus 100 integrates the command statement 912 for class instantiation and the description 911 including the instance call will be described.

As illustrated in FIG. 10, for example, the information processing apparatus 100 updates the source code 600 to produce a state in which the command statement 912 for class instantiation and the description 911 including the instance call are converted into a command statement 1001. With this, from the viewpoint of specifying a combination of pieces of source code to be preferably allocated to the same worker, the information processing apparatus 100 may convert the source code to make it possible to appropriately compare the pieces of source code with each other.

For example, the information processing apparatus 100 may expand a function in the source code. For this reason, for example, the information processing apparatus 100 may specify the source code in which the processing content is directly described and the source code in which the above processing content is called as a function, as a combination of pieces of source code including the same processing content with ease. Accordingly, the information processing apparatus 100 may easily specify a combination of pieces of source code considered to be preferably allocated to the same worker because of having the same processing content, for example.

For example, the information processing apparatus 100 is capable of canceling a module name replacement in the source code. For this reason, the information processing apparatus 100 may easily specify the source code using the module name as it is and the source code using the replaced module name, as a combination of pieces of the source code using the same module, for example. Accordingly, the information processing apparatus 100 may easily specify a combination of pieces of source code considered to be preferably allocated to the same worker because of using the same module.

For example, the information processing apparatus 100 is capable of integrating the instantiation of a class and the instance call in the source code. For this reason, the information processing apparatus 100 may easily specify two or more pieces of source code using the same instance but having different instance descriptions, for example. Accordingly, the information processing apparatus 100 may easily specify a combination of pieces of source code considered to be preferably allocated to the same worker because of using the same instance.

The information processing apparatus 100 converts pieces of source code in order to compare the pieces of source code with each other, and therefore the converted source code is not normally requested to be in an executable form. Next, an example in which the information processing apparatus 100 classifies a source code group into groups as many as the number of workers based on the converted source code will be described with reference to FIGS. 11 to 14.

FIGS. 11 to 14 are explanatory diagrams illustrating an example in which a source code group is classified into groups as many as the number of workers. In FIG. 11, the information processing apparatus 100 generates ASTs corresponding to the converted source code. An AST is a tree structure that includes nodes representing elements such as modules, functions, arrays, or values that appear in source code after conversion, and represents relationships between the elements by edges. For example, a tree structure 1100 in FIG. 11 illustrates part of a tree structure representing a processing content for calculating BMI in the converted source code 600 among the ASTs corresponding to the converted source code 600.

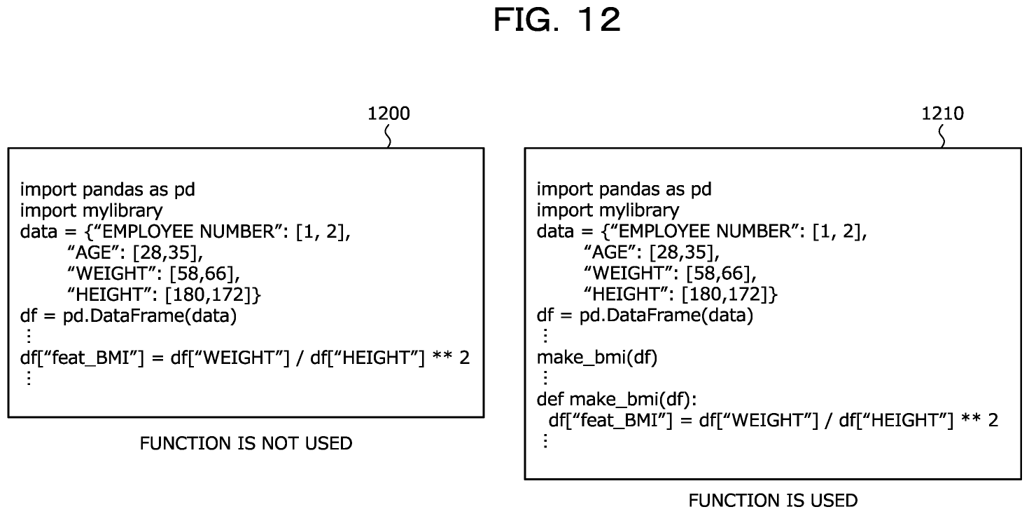

By comparing the generated ASTs, the information processing apparatus 100 specifies a combination of pieces of source code corresponding to each other and considered to be preferably allocated to the same worker. The combination of pieces of source code corresponding to each other is, for example, a combination of pieces of source code including the same processing content or processing contents similar to each other. Referring to description in FIG. 12, an example in which the information processing apparatus 100 specifies a combination of pieces of source code corresponding to each other will be described.

In FIG. 12, after the conversion processing, the information processing apparatus 100 judges whether ASTs respectively corresponding to two or more different pieces of source code include the same subtree. After the conversion processing, when the ASTs respectively corresponding to two or more different pieces of source code include the same subtree, the information processing apparatus 100 judges that the two or more pieces of source code correspond to each other. With this, the information processing apparatus 100 may specify a combination of pieces of source code considered to be preferably allocated to the same worker because of having the same processing content.

For example, there may be a case where the information processing apparatus 100 acquires source code 1200 directly describing a processing content therein and source code 1210 calling the processing content as a function. In this case, after the conversion processing, the AST corresponding to the source code 1200 and the AST corresponding to the source code 1210 are the same AST. Thus, the information processing apparatus 100 may specify a combination of pieces of source code considered to be preferably allocated to the same worker because of having the same processing content by the conversion processing.

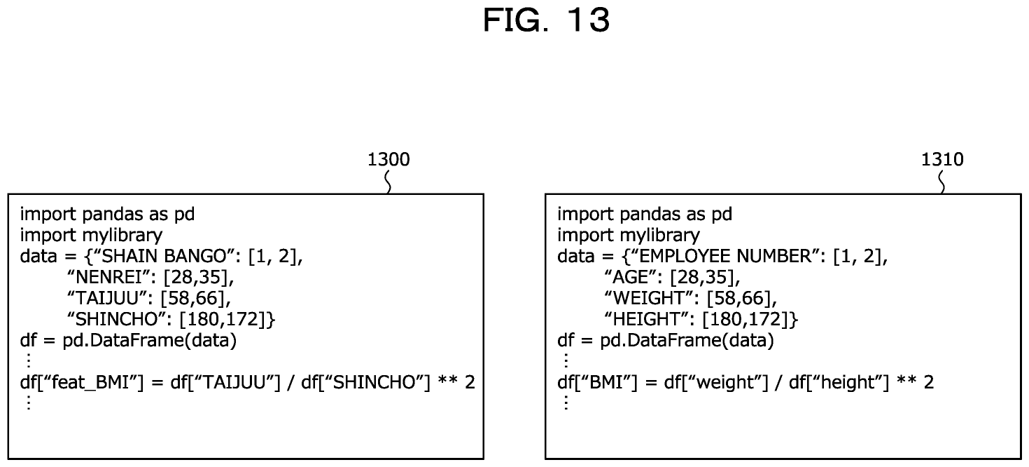

In contrast, in a case where the AST corresponding to the source code 1200 and the AST corresponding to the source code 1210 are compared without experiencing the conversion processing, the AST corresponding to the source code 1200 and the AST corresponding to the source code 1210 are judged to be different from each other. Accordingly, it may not be judged by the related art that the source code 1200 corresponds to the source code 1210. For this reason, it is not possible to specify a combination of pieces of source code considered to be preferably allocated to the same worker. Next, referring to description in FIG. 13, another example in which the information processing apparatus 100 specifies a combination of pieces of source code corresponding to each other will be described.

In FIG. 13, after the conversion processing, the information processing apparatus 100 masks variable names in the ASTs respectively corresponding to two or more pieces of source code, and thereafter judges whether each of the ASTs after the masking includes the same subtree. For example, the information processing apparatus 100 masks elements below Constant (value=character string) in the AST and treats them as optional elements.

After the masking, when the ASTs respectively corresponding to two or more different pieces of source code include the same subtree, the information processing apparatus 100 judges that the two or more pieces of source code correspond to each other. With this, the information processing apparatus 100 may specify a combination of pieces of source code considered to be preferably allocated to the same worker because of including similar processing contents. The information processing apparatus 100 may specify a combination of two or more pieces of source code including the processing contents different only in variable names to be treated from each other, for example.

For example, a case where the information processing apparatus 100 acquires source code 1300 including variable names such as “TAIJUU” and “SHINCHO” and source code 1310 including variable names such as “weight” and “height” is conceivable. In this case, after the masking, the AST corresponding to the source code 1300 and the AST corresponding to the source code 1310 are treated as the same AST. Thus, the information processing apparatus 100 may specify a combination of pieces of source code considered to be preferably allocated to the same worker because of including similar processing contents by the masking.

Without knowledge information on the correspondence between “TAIJUU” and “weight”, or the like, the information processing apparatus 100 may specify a combination of pieces of source code considered to be preferably allocated to the same worker by the masking.

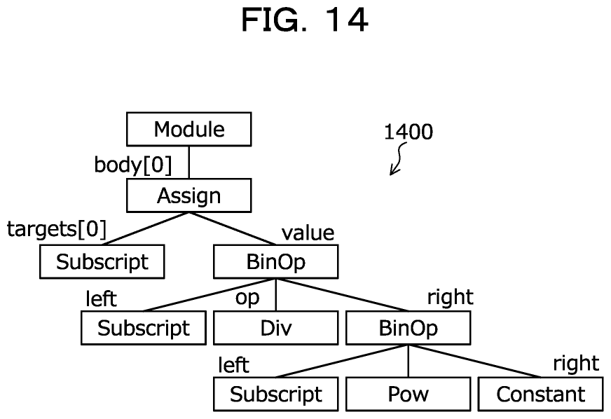

In contrast, in a case where the AST corresponding to the source code 1300 and the AST corresponding to the source code 1310 are compared without masking, the AST corresponding to the source code 1300 and the AST corresponding to the source code 1310 are judged to be different from each other. Accordingly, it may not be judged by the related art that the source code 1300 corresponds to the source code 1310. For this reason, it is not possible to specify a combination of pieces of source code considered to be preferably allocated to the same worker. Next, referring to description in FIG. 14, another example in which the information processing apparatus 100 specifies a combination of pieces of source code corresponding to each other will be described.

In FIG. 14, after the conversion processing, the information processing apparatus 100 partially masks ASTs respectively corresponding to two or more different pieces of source code, and thereafter judges whether each of the ASTs after the masking includes a subtree representing the same formula structure. For example, the information processing apparatus 100 masks elements below Subscript in the AST to treat them as optional elements, and judges whether each of the ASTs after the masking includes a subtree representing the same formula structure. The AST after the masking is, for example, an AST 1400 illustrated in FIG. 14.

After the masking, when the ASTs respectively corresponding to two or more different pieces of source code include subtrees representing the same formula structure, the information processing apparatus 100 judges that the two or more pieces of source code correspond to each other. With this, the information processing apparatus 100 may specify a combination of pieces of source code considered to be preferably allocated to the same worker because of including the same formula structure.

In the related art, ASTs are compared with each other without masking. Due to this, it is not possible to specify a combination of pieces of source code considered to be preferably allocated to the same worker because of including the same formula structure. Next, referring to description in FIG. 15, an example in which the information processing apparatus 100 allocates a source code group to a plurality of workers will be described.

FIG. 15 is an explanatory diagram illustrating an example in which a source code group is allocated to a plurality of workers. In FIG. 15, it is assumed that the information processing apparatus 100 has acquired a source code group 1500 including source code A, source code B, source code C, and source code D. Assume that the information processing apparatus 100 specifies the source code B and the source code C as a combination of corresponding pieces of source code. The information processing apparatus 100 allocates the source code A, B, C, and D to workers X and Y in such a manner that the combination of the source code B and source code C corresponding to each other is allocated to the same worker.

The information processing apparatus 100 classifies the source code A, B, C, and D into groups as many as the number of workers in such a manner that the combination of the source code B and source code C is included in the same group. For example, the information processing apparatus 100 classifies the source code A and source code D into a group 1510 corresponding to the worker X, and classifies the source code B and source code C into a group 1520 corresponding to the worker Y.

By transmitting the group 1510 to the client apparatus 201 corresponding to the worker X, the information processing apparatus 100 requests the worker X to perform annotation work on the source code A and source code D of the group 1510. By transmitting the group 1520 to the client apparatus 201 corresponding to the worker Y, the information processing apparatus 100 requests the worker Y to perform annotation work on the source code B and source code C of the group 1520.

At the time of the annotation work, the information processing apparatus 100 may allow the worker to refer to the source code having experienced the conversion processing. At the time of the annotation work, the information processing apparatus 100 may allow the worker to refer to the source code before experiencing the conversion processing. Thus, the information processing apparatus 100 may enable a plurality of workers to share and perform annotation work while suppressing the increase in workloads on the workers.

As described above, when a source code group is allocated to two or more workers, the information processing apparatus 100 may consider a duplicate portion, the same portion, a similar portion, or the like between the pieces of source code, and may suppress the increase in workloads on the workers. For example, the information processing apparatus 100 may suppress an increase in a workload on the worker when carefully examining the source code. For example, when the worker performs annotation work on any source code and then performs annotation work on another piece of source code having a duplicate portion with the above-mentioned source code, the information processing apparatus 100 may enable the worker to consider the duplicate portion.

Because the information processing apparatus 100 may compare pieces of source code with each other after expanding functions, the pieces of source code having the common processing content may be specified with high accuracy. The information processing apparatus 100 may suppress a situation in which source code calling a function is associated with source code describing the called function therein. The information processing apparatus 100 may specify a combination of pieces of source code having the common processing content and considered to be preferably allocated to the same worker to perform annotation work on the pieces of source code together, and may easily suppress the increase in workloads on the workers.

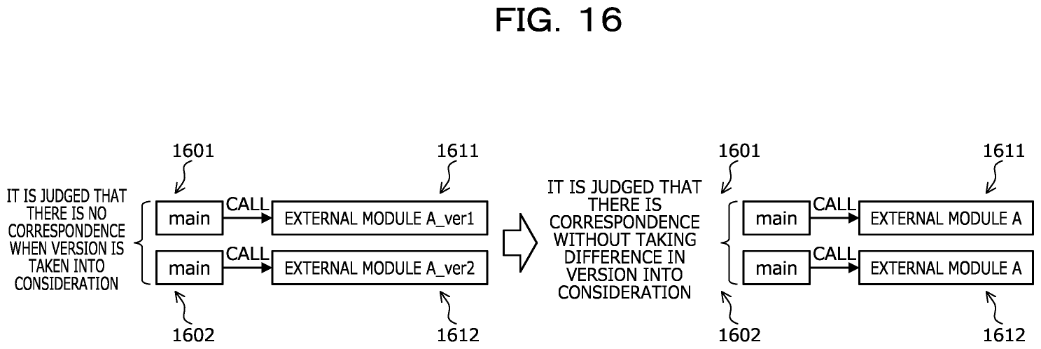

The information processing apparatus 100 may select a function to be expanded based on whether the function is described for a module developed by a developer. This makes it possible for the information processing apparatus 100 to reduce a processing load applied to the processing of the source code. The information processing apparatus 100 may suppress an increase in size of the AST corresponding to the source code, and may reduce a processing load for comparison of the ASTs. In the following, an example of an effect of the information processing apparatus 100 selecting a function to be expanded will be described with reference to FIG. 16.

FIG. 16 is an explanatory diagram illustrating an example of an effect of selecting a function to be expanded. As illustrated in FIG. 16, it is assumed that there exist source code 1601 calling an external module 1611, which is not developed by a developer, and source code 1602 calling an external module 1612, which is different in version from the external module 1611 and is not developed by the developer.

When a function regarding the external module 1611 not developed by the developer is expanded and a function regarding the external module 1612 not developed by the developer is expanded, there is a case in which the source code 1601 after the expansion and the source code 1602 after the expansion match with each other. However, in some case, a module that is not developed by a developer is not requested to be considered in annotation work. For example, a module not developed by a developer is likely to be treated as a black box, and thus it may be preferable not to consider the module in annotation work.

On the other hand, it may be preferable for a module developed by a developer to be considered in annotation work because of being relatively strongly related to the processing content of the source code. The information processing apparatus 100 may be allowed not to expand a function regarding a module that is not developed by a developer. In contrast, as illustrated in FIG. 16, the information processing apparatus 100 may specify that the source code 1601 corresponds to the source code 1602 without considering the version difference between the external modules 1611 and 1612.

As described above, the information processing apparatus 100 does not expand a function that is preferably not considered in the annotation work, and may expand a function that is preferably considered in the annotation work. Because of this, the information processing apparatus 100 may improve the efficiency of the annotation work and may suppress the increase in the workloads on the workers.

(Overall Processing Procedure)

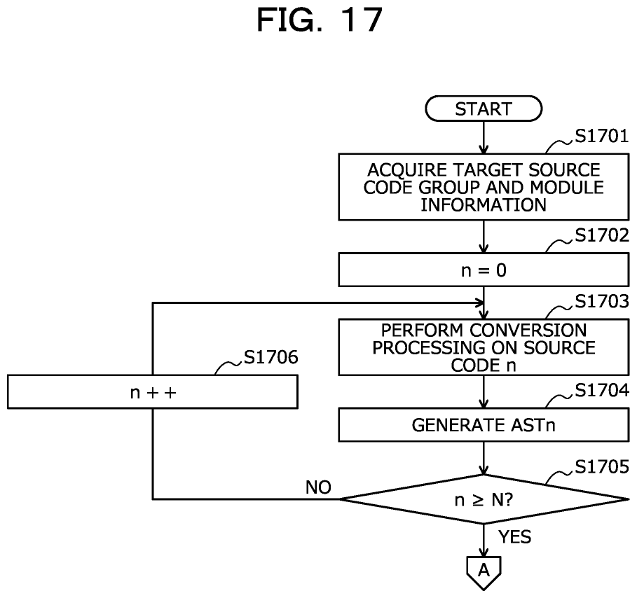

Next, an example of an overall processing procedure executed by the information processing apparatus 100 will be described with reference to FIGS. 17 to 19. The overall processing is implemented, for example, by the CPU 301, the storage areas such as the memory 302 and the recording medium 305, and the network I/F 303 illustrated in FIG. 3.

FIGS. 17 to 19 are flowcharts illustrating an example of the overall processing procedure. In FIG. 17, the information processing apparatus 100 acquires a target source code group and module information (step S1701). Then, the information processing apparatus 100 sets n to be 0 (step S1702).

Subsequently, the information processing apparatus 100 performs conversion processing on source code n in the target source code group (step S1703). Then, the information processing apparatus 100 generates an ASTn corresponding to the source code n after the conversion processing (step S1704).

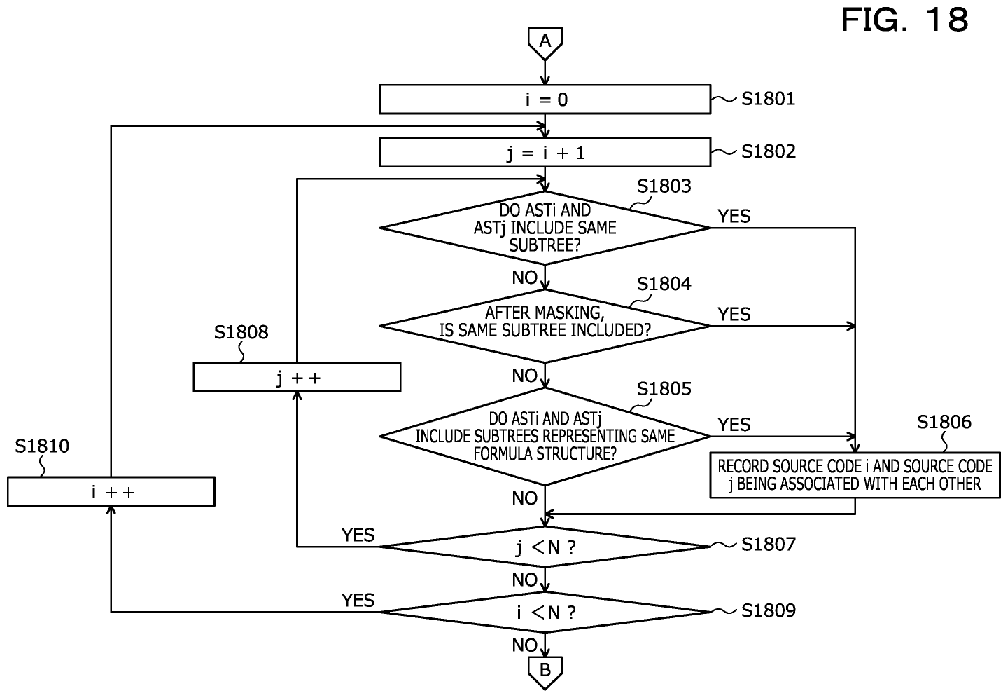

Subsequently, the information processing apparatus 100 judges whether a relation of n≥N is satisfied (step S1705). N is the number of pieces of source code. In a case where the relation of n≥N is not satisfied and n is smaller than N (step S1705: No), the information processing apparatus 100 sets n to be n++(step S1706), and returns to the processing of step S1703. On the other hand, in a case where the relation of n≥N is satisfied (step S1705: Yes), the information processing apparatus 100 proceeds to the processing of step S1801 in FIG. 18. The description is continued referring to FIG. 18.

In FIG. 18, the information processing apparatus 100 sets i to be 0 (step S1801). Then, the information processing apparatus 100 sets j to be i+1 (step S1802).

Subsequently, the information processing apparatus 100 acquires an ASTi corresponding to source code i and an ASTj corresponding to source code j among the source code group after the conversion processing. Then, the information processing apparatus 100 judges whether the same subtree is included in the acquired ASTi corresponding to the source code i and in the acquired ASTj corresponding to the source code j (step S1803). When the same subtree is included therein (step S1803: Yes), the information processing apparatus 100 proceeds to the processing of step S1806. On the other hand, when the same subtree is not included (step S1803: No), the information processing apparatus 100 proceeds to the processing of step S1804.

In step S1804, the information processing apparatus 100 judges, after masking the elements regarding variable names included in the acquired ASTi corresponding to the source code i and in the acquired ASTj corresponding to the source code j, whether the same subtree is included (step S1804). When the same subtree is included (step S1804: Yes), the information processing apparatus 100 proceeds to the processing of step S1806. On the other hand, when the same subtree is not included (step S1804: No), the information processing apparatus 100 proceeds to the processing of step S1805.

In step S1805, the information processing apparatus 100 judges whether subtrees representing the same formula structure are respectively included in the acquired ASTi corresponding to the source code i and in the acquired ASTj corresponding to the source code j (step S1805). In a case where the subtrees representing the same formula structure are included (step S1805: Yes), the information processing apparatus 100 proceeds to the processing of step S1806. On the other hand, when the subtrees representing the same formula structure are not included (step S1805: No), the information processing apparatus 100 proceeds to the processing of step S1807.

In step S1806, the information processing apparatus 100 records the source code i and source code j being associated with each other in the task DB (step S1806). Then, the information processing apparatus 100 proceeds to the processing of step S1807.

In step S1807, the information processing apparatus 100 judges whether j is smaller than N (step S1807). In a case where j is smaller than N (step S1807: Yes), the information processing apparatus 100 sets j to be j++(step S1808), and returns to the processing of step S1803. On the other hand, in a case where j is not smaller than N and a relation of j N is satisfied (step S1807: No), the information processing apparatus 100 proceeds to the processing of step S1809.

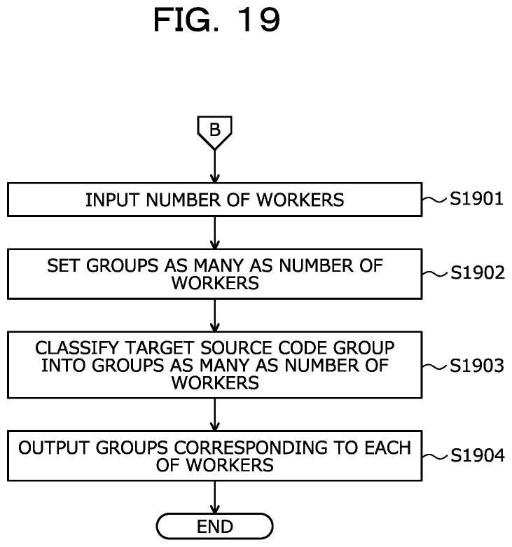

In step S1809, the information processing apparatus 100 judges whether i is smaller than N (step S1809). In a case where i is smaller than N (step S1809: Yes), the information processing apparatus 100 sets i to be i++(step S1810), and returns to the processing of step S1802. On the other hand, in a case where i is not smaller than N and a relation of j≥N is satisfied (step S1809: No), the information processing apparatus 100 proceeds to the processing of step S1901 in FIG. 19. The description is continued referring to FIG. 19.

In FIG. 19, the information processing apparatus 100 receives input of the number of workers (step S1901). Subsequently, the information processing apparatus 100 sets groups as many as the input number of workers respectively corresponding to different workers (step S1902).

By referring to the task DB, the information processing apparatus 100 classifies the target source code group into groups as many as the number of workers in such a manner that the pieces of source code associated with each other are included in the same group (step S1903).

Subsequently, the information processing apparatus 100 outputs the groups corresponding to each of the workers in such a manner that the worker is able to refer to the corresponding group (step S1904). Then, the information processing apparatus 100 ends the overall processing. Thus, the information processing apparatus 100 may suppress the increase in the workload on the worker when performing annotation work.

(Conversion Processing Procedure)

Next, an example of a conversion processing procedure executed by the information processing apparatus 100 will be described with reference to FIG. 20. The conversion processing is implemented, for example, by the CPU 301, the storage areas such as the memory 302 and the recording medium 305, and the network I/F 303 illustrated in FIG. 3.

FIG. 20 is a flowchart illustrating an example of the conversion processing procedure. In FIG. 20, the information processing apparatus 100 refers to an external module list and assigns flag information, to a module included in the source code n, indicating whether the module is developed by a developer (step S2001).

Subsequently, the information processing apparatus 100 performs name resolution on an import statement included in the source code n (step S2002). By referring to the flag information, the information processing apparatus 100 expands a function corresponding to a module included in the source code n and not developed by the developer (step S2003).

Subsequently, the information processing apparatus 100 integrates the instantiation of a class included in the source code n and the instance call (step S2004). Then, the information processing apparatus 100 ends the conversion processing. Thus, the information processing apparatus 100 may convert pieces of source code in such a manner that the processing contents of different pieces of source code may be appropriately and easily compared.

The information processing apparatus 100 may execute the processing in each of the flowcharts illustrated in FIGS. 17 to 20 while interchanging the processing order of some steps. For example, the order of the processing in steps S1803 to S1805 is interchangeable. The information processing apparatus 100 may skip the processing in some steps in each of the flowcharts illustrated in FIGS. 17 to 20. For example, the processing of steps S1803 to S1805 may be skipped.

As described above, the information processing apparatus 100 may acquire a plurality of pieces of source code. According to the information processing apparatus 100, it is possible to judge, for each of the plurality of pieces of source code acquired, whether a definition of a module is included in the source code. According to the information processing apparatus 100, in the case where a definition of a module is included in the source code, when the module is not included in the predetermined library, it is possible to expand a function corresponding to the module in the source code. According to the information processing apparatus 100, it is possible to specify a group including two or more pieces of source code to be subjected to annotation work together among the plurality of pieces of source code, based on a result of comparing each of the plurality of pieces of source code with each other after expansion. Thus, the information processing apparatus 100 may easily allocate two or more pieces of source code corresponding to each other to the same worker, and may suppress the increase in the workload on the worker who performs annotation work.

According to the information processing apparatus 100, it is possible to judge, for each of the plurality of pieces of source code, whether a definition of a module including the replacement of the name of the module is included in the source code. According to the information processing apparatus 100, in a case where a definition of a module including the replacement of the name of the module is included in the source code, it is possible to cancel the replacement of the name of the module in the source code. Thus, the information processing apparatus 100 may specify two or more pieces of source code corresponding to each other with high accuracy in consideration of the replacement of the name of the module.

According to the information processing apparatus 100, it is possible to judge whether a definition of a class regarding the module is included in each of the plurality of pieces of source code. According to the information processing apparatus 100, in a case where a definition of a class is included in the source code, it is possible to convert an instance call using a name of the class in the source code into an instance call using a name of the module. Thus, the information processing apparatus 100 may specify two or more pieces of source code corresponding to each other with high accuracy in consideration of class instantiation.

According to the information processing apparatus 100, it is possible to generate an abstract syntax tree corresponding to each of the plurality of pieces of source code after expansion. According to the information processing apparatus 100, it is possible to specify a group including pieces of source code corresponding to each of two or more different abstract syntax trees including subtrees having the same content among the generated abstract syntax trees. Thus, the information processing apparatus 100 may accurately specify two or more pieces of source code corresponding to each other and considered to be preferably subjected to annotation work together.

According to the information processing apparatus 100, when a variable name is included in each of the plurality of pieces of source code after being expanded, it is possible to generate an abstract syntax tree corresponding to the source code in which the variable name is replaced with mask data. According to the information processing apparatus 100, it is possible to specify a group including pieces of source code corresponding to each of two or more different abstract syntax trees including subtrees having the same content among the generated abstract syntax trees. Thus, the information processing apparatus 100 may accurately specify two or more pieces of source code corresponding to each other and considered to be preferably subjected to annotation work together.

According to the information processing apparatus 100, it is possible to specify a group including pieces of source code corresponding to each of two or more different abstract syntax trees including subtrees representing same formula structure among the generated abstract syntax trees. Thus, the information processing apparatus 100 may accurately specify two or more pieces of source code corresponding to each other and considered to be preferably subjected to annotation work together.

According to the information processing apparatus 100, it is possible to output pieces of information respectively indicating two or more pieces of source code included in the specified group in the form of being associated with each other. With this, the information processing apparatus 100 may request the worker to perform annotation work. The information processing apparatus 100 enables the worker to recognize two or more pieces of source code corresponding to each other, and may easily reduce the workload applied to the worker.

The information processing method described in the embodiment may be implemented by causing a computer, such as a personal computer (PC) or a workstation, to execute a program prepared in advance. The information processing program described in the embodiment is recorded in a computer-readable recording medium, and is read from the recording medium by the computer and executed by the computer. The recording medium is a hard disk, a flexible disk, a compact disc (CD)-ROM, a magneto-optical (MO) disk, a Digital Versatile Disc (DVD), or the like. The information processing program described in the embodiment may be distributed via a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a process, the process comprising:
acquiring a plurality of pieces of source code;
making an expansion of a function corresponding to a module in source code in a case in which a definition of the module is included in the source code and when the module is not included in a predetermined library, for each of the plurality of pieces of source code acquired; and
specifying a group including two or more pieces of source code to be subjected to annotation work together among the plurality of pieces of source code, based on a result of comparing each of the plurality of pieces of source code after the expansion.

2. The non-transitory computer-readable recording medium according to claim 1,
wherein the expanding a function includes canceling replacement of a name of a module in source code when the source code includes a definition of the module including the replacement of the name of the module, for each of the plurality of pieces of source code.

3. The non-transitory computer-readable recording medium according to claim 1,
wherein, in each of the plurality of pieces of source code, when a definition of a class and an instance call using a name of the class are included, the expanding a function includes integrating the instance call using the name of the class with the definition of the class in the source code.

4. The non-transitory computer-readable recording medium according to claim 1,
wherein the specifying a group includes,
generating abstract syntax trees corresponding to each of the plurality of pieces of source code after the expansion, and
specifying the group including the pieces of source code corresponding to each of two or more different abstract syntax trees including subtrees having an identical content among the generated abstract syntax trees.

5. The non-transitory computer-readable recording medium according to claim 1,
wherein the specifying a group includes,
generating an abstract syntax tree, when a variable name is included in each of the plurality of pieces of source code after the expansion, that corresponds to the source code and has the variable name replaced with mask data, and
specifying the group including the pieces of source code corresponding to each of two or more different abstract syntax trees including subtrees having an identical content among the generated abstract syntax trees.

6. The non-transitory computer-readable recording medium according to claim 4,
wherein the specifying a group includes specifying the group including the pieces of source code respectively corresponding to two or more different abstract syntax trees including subtrees representing an identical formula structure among the generated abstract syntax trees.

7. The non-transitory computer-readable recording medium according to claim 1, further comprising:
outputting pieces of information respectively indicating the two or more pieces of source code included in the specified group in a form of the information being associated with the source code.

8. An information processing method comprising:
acquiring a plurality of pieces of source code;
making an expansion of a function corresponding to a module in source code in a case in which a definition of the module is included in the source code and when the module is not included in a predetermined library, for each of the plurality of pieces of source code acquired; and
specifying a group including two or more pieces of source code to be subjected to annotation work together among the plurality of pieces of source code, based on a result of comparing each of the plurality of pieces of source code after the expansion.

9. An information processing apparatus comprising:
a memory; and
a processor coupled to the memory and configured to:
acquire a plurality of pieces of source code;
make an expansion of a function corresponding to a module in source code in a case in which a definition of the module is included in the source code and when the module is not included in a predetermined library, for each of the plurality of pieces of source code acquired; and
specify a group including two or more pieces of source code to be subjected to annotation work together among the plurality of pieces of source code, based on a result of comparing each of the plurality of pieces of source code after the expansion.
